(19) United States
(12) Patent Application Publication
(10) Pub. No.: US 2016/0020510 A1
(43) Pub. Date: Jan. 21, 2016

(54) STRUCTURAL BODY AND WIRELESS COMMUNICATION DEVICE

(71) Applicant: Sharp Kabushiki Kaisha, Osaka-shi, Osaka (JP)

(72) Inventor: Yuhsuke OKAJIMA, Osaka-shi (JP)

(21) Appl. No.: 14/771,530

(22) PCT Filed: Jan. 17, 2014
(86) PCT No.: PCT/JP2014/050830

§ 371 Date: Aug. 31, 2015

(30) Foreign Application Priority Data
Mar. 21, 2013 (JP) 2013-059148

(51) Int. Cl. H01Q 1/38; H01Q 1/24

(52) U.S. Cl. CPC H01Q 1/38; H01Q 1/24

(57) ABSTRACT

A first resin layer (1) of a structure (10) has thereon a missing part (4) in which an electrically conductive pattern (3) is missing, and the first resin layer (1) and a second resin layer (2) adhere to each other in the missing part (4).

### TECHNICAL FIELD

The present invention relates to a structure including an electrically conductive pattern, and to a wireless communication apparatus including the structure.

### BACKGROUND ART

In order to make an electronic device thinner and cause the electronic device to have a simpler structure, there has recently been developed a technique for integrally molding an electrically conductive pattern with a housing.

For example, Patent Literature 1 discloses a case body for an electronic device, including: an antenna; and a substrate including (i) a primary molding layer bonded to a first surface of the antenna by primary injection molding and (ii) a secondary molding layer bonded to a second surface of the antenna by secondary injection molding, the primary molding layer and the secondary molding layer each covering at least a part of the antenna.

### CITATION LIST

### Patent Literature

Patent Literature 1

Japanese Patent Application Publication Tokukai No. 2012-44654 (Publication date: Mar. 1, 2012)

### SUMMARY OF INVENTION

### Technical Problem

Patent Literature 1 discloses a technique in which (i) a first part of the primary molding layer to which first part no antenna is bonded and (ii) the secondary molding layer favorably closely adhere (adhere) to each other during the secondary injection molding. However, according to the technique, since a second part of the primary molding layer to which second part the antenna is bonded less strongly adheres to the secondary molding layer, the primary molding layer and the secondary molding layer may be separated from each other at an interface therebetween.

The present invention has been made in view of the problem, and a main object of the present invention is to provide a technique for, in a structure including: a first resin layer; a second resin layer; and an electrically conductive pattern provided on a surface of the first resin layer, the second resin layer being stacked on the first resin layer so that the electrically conductive pattern is provided between the first resin layer and the second resin layer, preventing separation of the first resin layer and the second resin layer in a part in which the electrically conductive pattern is provided.

### Solution to Problem

In order to attain the object, a structure in accordance with an aspect of the present invention includes: a first resin layer; a second resin layer; and an electrically conductive pattern provided on a surface of the first resin layer, the second resin layer being stacked on the first resin layer so that the electrically conductive pattern is provided between the first resin layer and the second resin layer, the first resin layer having thereon at least one missing part in which the electrically conductive pattern is missing, and the first resin layer and the second resin layer adhering to each other in the at least one missing part.

### Advantageous Effects of Invention

According to an aspect of the present invention, the missing part in which the electrically conductive pattern is missing is provided on the first resin layer, and the first resin layer and the second resin layer adhere to each other in the missing part. This makes it possible to prevent separation of the first resin layer and the second resin layer in a part in which the electrically conductive pattern is provided.

### BRIEF DESCRIPTION OF DRAWINGS

(a) of FIG. 1 is a side cross-sectional view schematically illustrating a configuration of a structure in accordance with an embodiment (Embodiment 1) of the present invention. (b) of FIG. 1 is a top view of the structure which is observed from the first resin layer side.

FIG. 2 schematically illustrates an overview of a process for producing the structure in accordance with the embodiment (Embodiment 1) of the present invention.

(a) of FIG. 3 is a side cross-sectional view schematically illustrating a configuration of a structure in accordance with an embodiment (Embodiment 2) of the present invention. (b) of FIG. 3 is a top view of the structure which is observed from the first resin layer side.

FIG. 4 schematically illustrates an overview of a process for producing the structure in accordance with the embodiment (Embodiment 2) of the present invention.

FIG. 5 is a side cross-sectional view schematically illustrating a configuration of a wireless communication apparatus in accordance with an embodiment (Embodiment 3) of the present invention.

FIG. 6 is a top view of the structure in accordance with the embodiment (Embodiment 3) of the present invention which structure is observed from the first resin layer side.

### DESCRIPTION OF EMBODIMENTS

A structure in accordance with the present invention includes: a first resin layer; a second resin layer; and an electrically conductive pattern provided on a surface of the first resin layer, the second resin layer being stacked on the first resin layer so that the electrically conductive pattern is provided between the first resin layer and the second resin layer, the first resin layer having thereon at least one missing part in which the electrically conductive pattern is missing, and the first resin layer and the second resin layer adhering to each other in the at least one missing part.

A wireless communication apparatus in accordance with the present invention includes: a housing including the structure in accordance with the present invention; and an antenna including the electrically conductive pattern.

(Brief Description of Structure)

A structure in accordance with the present invention provides a general electronic device with an electrically conductive pattern by being incorporated in the general electronic device that requires the electrically conductive pattern serving as, for example, an antenna element, a signal transmission path, or an electric power transmission path. For example, according to an embodiment of the present invention, the structure in accordance with the present invention is incorporated in a wireless communication apparatus so as to provide an antenna element to be provided in the wireless communication apparatus. Alternatively, the structure in accordance with the present invention can be incorporated in an electronic device so as to provide, for example, a signal transmission path or an electric power transmission path that electrically connects a circuit board and another electronic component, or to provide a path that connects a circuit board and a ground.

Note that the structure in accordance with the present invention can be fixed to or detachably mounted in an electronic device. Note also that according to an embodiment of the present invention, the structure in accordance with the present invention can constitute at least part of a housing of an electronic device. In other words, the structure in accordance with the present invention can be an electrically conductive pattern-formed housing. Note that a housing refers to a member storing an electronic component of an electronic device and that an electrically conductive pattern-formed housing refers to a housing in which an electrically conductive pattern is provided. Note, however, that the structure in accordance with the present invention, which structure is not limited to such a structure as described above, can be a member different from a housing of an electronic device.

According to the structure in accordance with the present invention, it is possible to prevent exposure, to an outside of the structure, of the electrically conductive pattern, which is provided between the first resin layer and the second resin layer. This makes it possible to maintain a fine appearance of the structure, and to prevent, for example, breakage, deformation, or deterioration in the electrically conductive pattern.

The first resin layer and the second resin layer are both injection-molded articles. The first resin layer and the second resin layer can be made of a single resin or different resins. A usable resin(s) of which the first resin layer and the second resin layer is made is exemplified by, but not limited to one or more kinds of resins selected from, for example, acrylonitrile-butadiene-styrene resin (ABS), polycarbonate-acrylonitrile-butadiene-styrene resin (PC-ABS), polycarbonate (PC), acrylonitrile-styrene resin (AS), polyethylene (PE), polypropylene (PP), polystyrene (PS), and polymethyl methacrylate resin (PMMA). Note that it is possible to mix such a resin as described above and another material such as glass so as to cause the first resin layer and the second resin layer to have a higher strength.

Further, in an aspect of the present invention, it is possible to use, as a resin of which the first resin layer is made, a resin that is more resistant to heat than a resin of which the second resin layer is made. This can prevent the resins of which the first resin layer and the second resin layer are made from excessively melting together during formation of the second resin layer. For example, PC can be used as the resin of which the first resin layer is made, and ABS can be used as the resin of which the second resin layer is made.

The electrically conductive pattern is a pattern made of an electrically conductive material provided on a surface of the first resin layer. The electrically conductive material is not particularly limited in kind provided that the electrically conductive material is electrically conductive. Examples of a usable electrically conductive material include: metals such as copper, iron, nickel, and gold; an electrically conductive polymer; and electrically conductive carbon. A method for forming the electrically conductive pattern is not particularly limited. The electrically conductive pattern can be formed by, for example, plating the first resin layer with metal, printing, on the surface of the first resin layer, electrically conductive paste containing the electrically conductive material, or pasting, on the surface of the first resin layer, a filmy electrically conductive material having flexibility such as copper foil. The electrically conductive material for use in formation of the electrically conductive pattern is not limited to one kind of electrically conductive material. The electrically conductive pattern can be formed by combining a plurality of electrically conductive materials, e.g., by plating a copper pattern with gold.

For example, according to an embodiment of the present invention, the electrically conductive pattern can be formed by a Laser Direct Structuring (LDS) method. That is, an organic metal is mixed with a resin of which the first resin layer is made, and a region of the surface of the first resin layer in which region the electrically conductive pattern is to be formed is irradiated with a laser. This makes it possible to suitably form the electrically conductive pattern by precipitating the organic metal to the region irradiated with a laser, making the region irradiated with a laser finely rough (uneven), and combining the organic metal and the region irradiated with a laser. According to another embodiment of the present invention, the electrically conductive pattern can be formed by a Direct Printed Antenna (DPA) method. The DPA method is a method in which a printing plate for forming the electrically conductive pattern is prepared in advance and a shape of the electrically conductive pattern is transferred from the printing plate to a resin surface by use of, for example, a pad.

According to the methods described earlier (especially the LDS method), since the electrically conductive pattern is formed on the surface of the first resin layer by laser irradiation, the first resin layer and the electrically conductive pattern considerably more closely adhere to each other.

Further, according to the structure in accordance with the present invention, the first resin layer has thereon the at least one missing part in which the electrically conductive pattern is missing. In the at least one missing part, the first resin layer and the second resin layer adhere to each other. This makes it possible for the first resin layer and the second resin layer to more strongly adhere to each other in a part in which the electrically conductive pattern is provided, and consequently to prevent separation of the first resin layer and the second resin layer. Note that at least one of the at least one missing part is preferably a missing part in which the electrically conductive pattern is missing so as to have an island shape.

Note that the wording “a missing part in which the electrically conductive pattern is missing so as to have an island shape” herein refers to a part of the first resin layer in which part no electrically conductive pattern is provided and which part exists as if it were an island assuming that the electrically conductive pattern is a sea area. Specifically, (i) a part of the first resin layer which part is surrounded by the electrically conductive pattern and (ii) a part in which the electrically conductive pattern which is provided in an end portion of the first resin layer is missing on the first resin layer end side of the electrically conductive pattern each fall under the wording.

For example, the structure in accordance with the present invention can be produced as below. First, the first resin layer is formed in a desired shape by use of a publicly-known injection molding technique (a first resin layer forming step). Next, the electrically conductive pattern is formed on the surface of the first resin layer by use of the method described earlier (an electrically conductive pattern forming step). In this case, the electrically conductive pattern can be formed so that the missing part is provided in advance. Alternatively, the missing part can be formed by forming the electrically conductive pattern in a state in which no missing part is present, and thereafter removing a part of the electrically conductive pattern.

Thereafter, the second resin layer is stacked on the first resin layer so that the electrically conductive pattern is provided between the first resin layer and the second resin layer (a stacking step). In the stacking step, the second resin layer is preferably integrally molded, by insert-molding, with the first resin layer, which has already been formed. That is, by molding (insert-molding) the second resin layer while the first resin layer is provided in a mold, the first resin layer and the second resin layer can favorably closely adhere (adhere) to each other in a region in which the electrically conductive pattern is absent and which includes the missing part.

Note that the present invention is not limited to the above. The stacking step can be carried out such that a publicly-known adhesive material such as a silicone adhesive or an epoxy resin adhesive is used to cause the second resin layer which is formed in advance by use of a publicly-known injection molding technique to adhere to the first resin layer. This also allows the first resin layer and the second resin layer to strongly adhere to each other particularly in the region in which the electrically conductive pattern is absent and which includes the missing part. This is because resins adhere to each other more strongly than a resin and an electrically conductive pattern (particularly a metallic electrically conductive pattern).

Subsequently, several embodiments of the present invention are specifically described below with reference to the drawings. Note that the technical scope of the present invention is not limited to the description of the embodiments below and of the drawings. It is possible to appropriately alter, for example, arrangement and/or presence of each of the members.

### Embodiment 1

(a) of FIG. 1 is a side cross-sectional view schematically illustrating a configuration of a structure 10 in accordance with an embodiment (Embodiment 1) of the present invention. As illustrated in (a) of FIG. 1, the structure 10 includes a first resin layer 1, a second resin layer 2, and an electrically conductive pattern 3. The first resin layer 1 and the second resin layer 2, which are stacked so that the electrically conductive pattern 3 is provided therebetween, adhere to each other in at least a part in which the first resin layer 1 and the second resin layer 2 are in direct contact with each other. Further, the first resin layer 1 and the second resin layer 2 adhere to each other in a missing part 4 of the first resin layer 1 in which missing part the electrically conductive pattern 3 is missing.

According to an example shown in (a) of FIG. 1, the second resin layer 2 is provided so as to protrude toward the missing part 4. Note, however, that the first resin layer 1, the second resin layer 2, and the missing part 4 are not particularly limited in shape, provided that the first resin layer 1 and the second resin layer 2 adhere to each other in the missing part 4. The missing part 4 of the first resin layer 1 can be provided so as to protrude toward the second resin layer 2. Alternatively, the first resin layer 1 and the second resin layer 2 can be provided so as to protrude toward each other, or the first resin layer 1 and the second resin layer 2 can be provided so that one of the first layer 1 and the second resin layer 2 is recessed and the other of the first layer 1 and the second resin layer 2 protrudes.

In the missing part 4, the first resin layer 1 and the second resin layer 2 can be closely adhered to each other (welded together) by insert-molding or can be adhered to each other by use of an adhesive.

(b) of FIG. 1 is a top view of the structure 10 which is observed from the first resin layer 1 side. As illustrated in (b) of FIG. 1, the missing part 4, which is formed by punching a hole in the electrically conductive pattern 3, is surrounded by the electrically conductive pattern 3.

According to an example shown in (b) of FIG. 1, the missing part 4 has a circular shape. Note, however, the missing part 4, which is not particularly limited in shape, can have any shape such as an elliptical shape, a quadrangular shape, or a polygonal shape. Further, the number of missing parts 4, which is not particularly limited, can be one, or two or more. Note, however, that a plurality of missing parts 4 are preferably provided so that the first resin layer 1 and the second resin layer 2 more strongly adhere to each other.

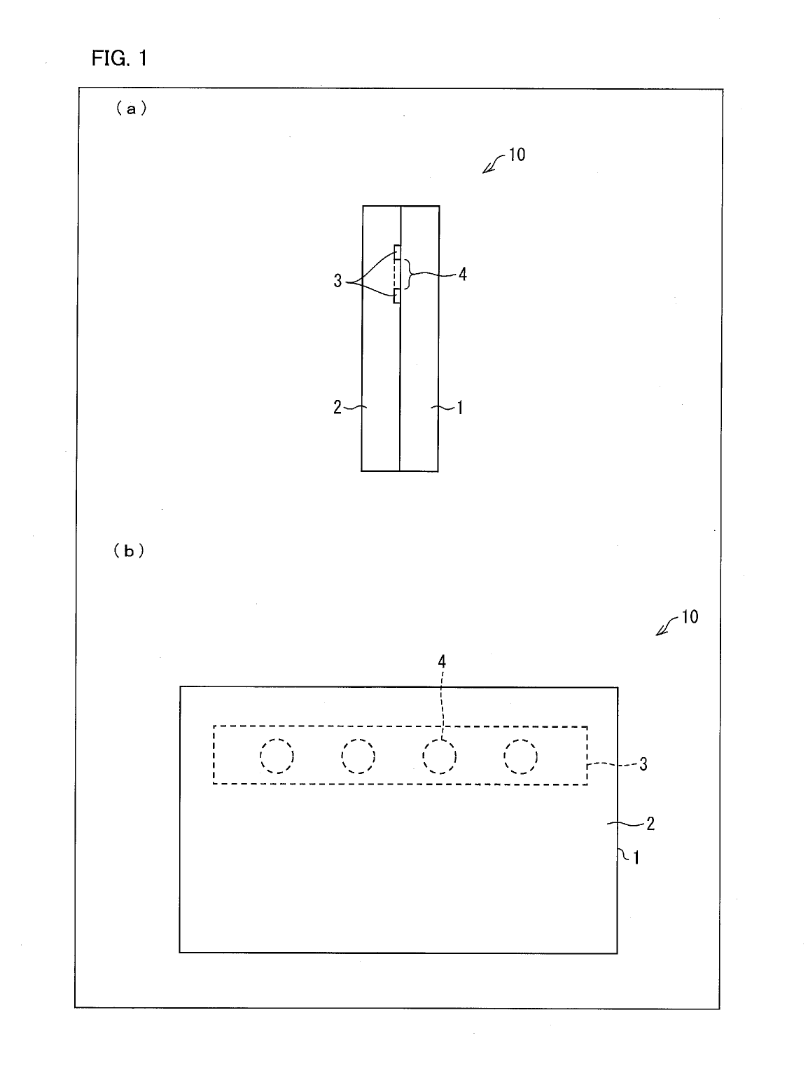

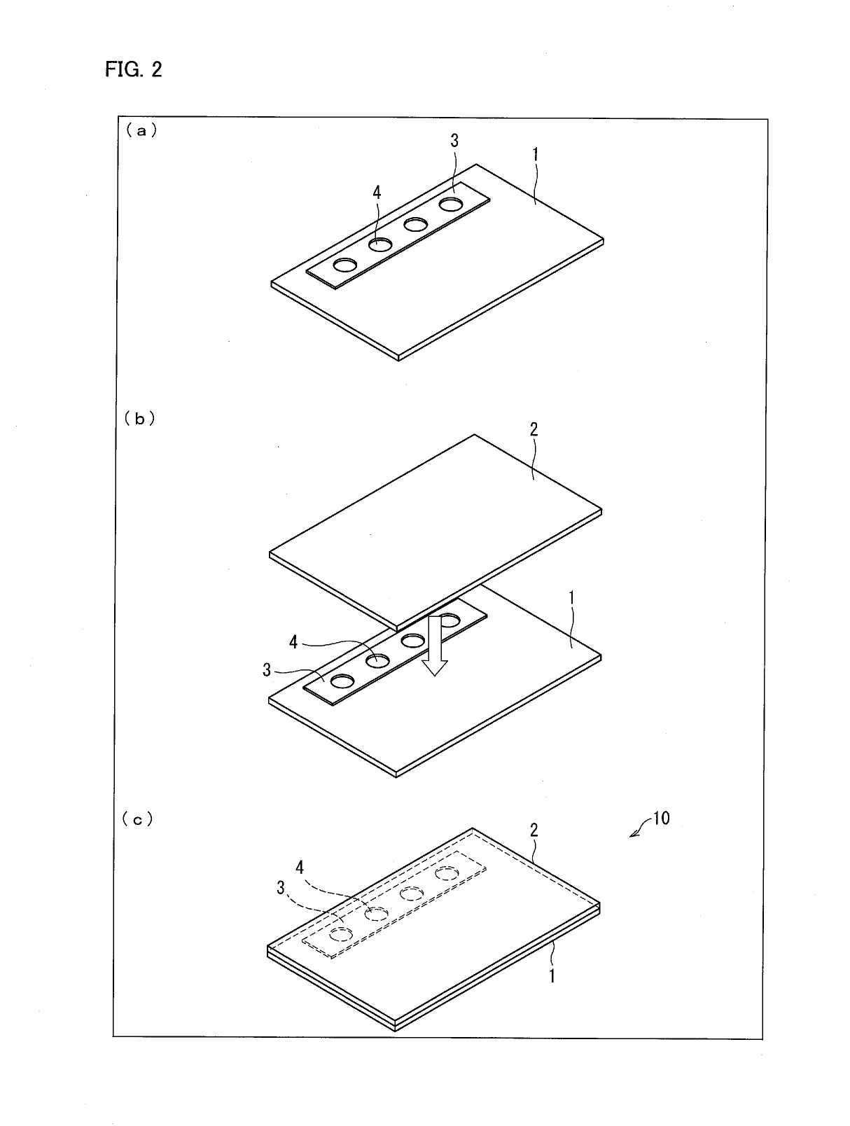

FIG. 2 schematically illustrates an overview of a process for producing the structure 10. First, the electrically conductive pattern 3 is formed on a surface of the first resin layer 1 ((a) of FIG. 2). Then, the second resin layer 2 is stacked on the first resin layer 1 so that the electrically conductive pattern 3 is provided between the first resin layer 1 and the second resin layer 2 ((b) of FIG. 2). Finally, the structure 10 is completed ((c) of FIG. 2).

### Advantages of Embodiment 1

According to Embodiment 1, the missing part 4 in which the electrically conductive pattern 3 is missing is provided on the first resin layer 1, and the first resin layer 1 and the second resin layer 2 adhere to each other in the missing part 4. This makes it possible to prevent separation of the first resin layer 1 and the second resin layer 2 in a part in which the electrically conductive pattern 3 is provided.

According to Embodiment 1, the missing part 4 is surrounded by the electrically conductive pattern 3. In other words, the missing part 4 is formed by punching a hole in the electrically conductive pattern 3. This makes it possible to provide the missing part 4 at any location and to suitably prevent separation of the first resin layer 1 and the second resin layer 2.

In particular, even in a case where the electrically conductive pattern 3 widely extends and a part of the first resin layer 1 in which part no electrically conductive pattern 3 is provided and the second resin layer 2 have a smaller area of contact therebetween, it is possible to suitably prevent separation of the first resin layer 1 and the second resin layer 2.

### Embodiment 2

Another embodiment (Embodiment 2) of the present invention is described below with reference to the drawings. Note that, for convenience, members having functions identical to those of the respective members described in Embodiment 1 are given respective identical reference numerals, and a description of those members is omitted.

(a) of FIG. 3 is a side cross-sectional view schematically illustrating a configuration of a structure 20 in accordance with Embodiment 2. (b) of FIG. 3 is a top view of the structure 20 which is observed from the first resin layer 1 side. As illustrated in FIG. 3, the structure 20 of Embodiment 2 is different from the structure 10 of Embodiment 1 in location and shape of an electrically conductive pattern 3 and of a missing part 4, but the structure 20 of Embodiment 2 is identical to the structure 10 of Embodiment 1 in other configuration.

As illustrated in (b) of FIG. 3, according to Embodiment 2, at least a part of the electrically conductive pattern 3 is provided in an end portion of a first resin layer 1. Note that the end portion of the first resin layer 1 refers a part at and near an end of the first resin layer 1. The electrically conductive pattern 3 and the first resin layer 1 can have a gap therebetween.

Further, the missing part 4 is a part in which a part of the electrically conductive pattern 3 (described earlier) is missing on the first resin layer 1 end side of the electrically conductive pattern 3. In other words, a first part of the missing part 4 which first part differs from a second part of the missing part 4 which second part faces the end of the first resin layer 1 is surrounded by the electrically conductive pattern 3.

According to an example shown in (b) of FIG. 3, the missing part 4 has a rectangular shape. Note, however, the missing part 4, which is not particularly limited in shape, can have any shape such as a circular shape, an elliptical shape, or a polygonal shape. Further, the number of missing parts 4, which is not particularly limited, can be one, or two or more. Note, however, that a plurality of missing parts 4 are preferably provided so that the first resin layer 1 and the second resin layer 2 more strongly adhere to each other.

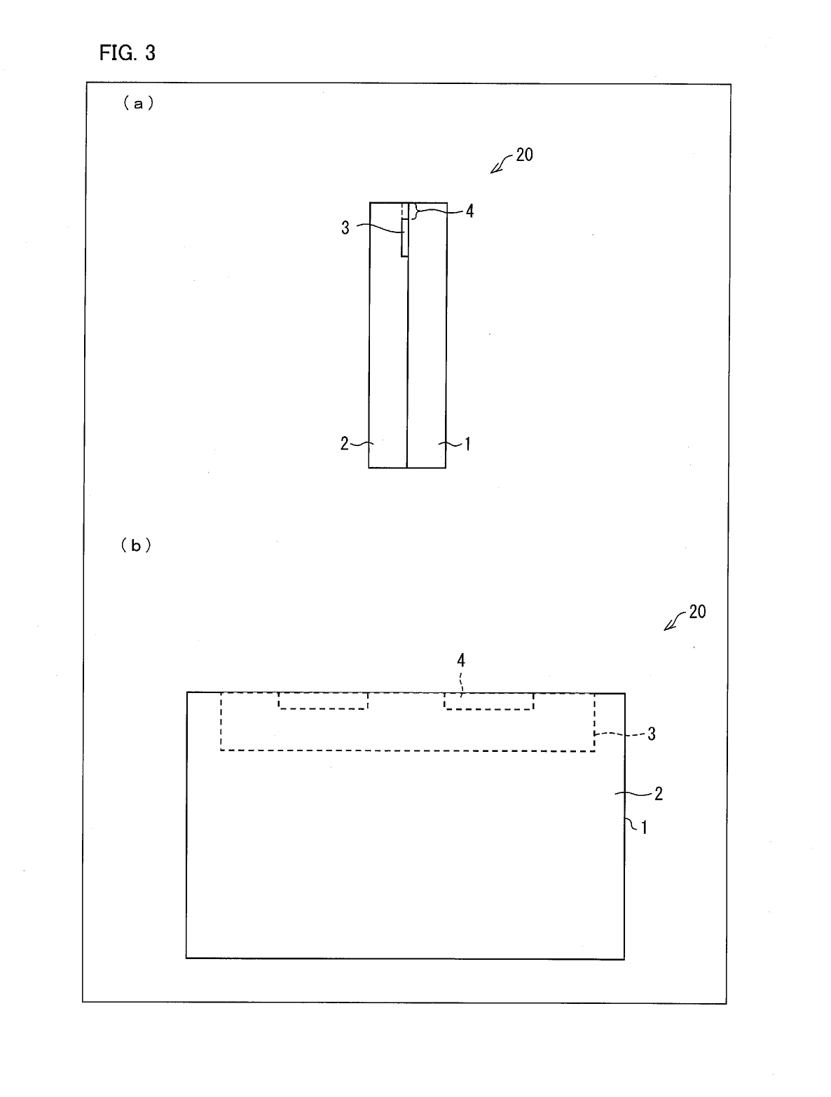

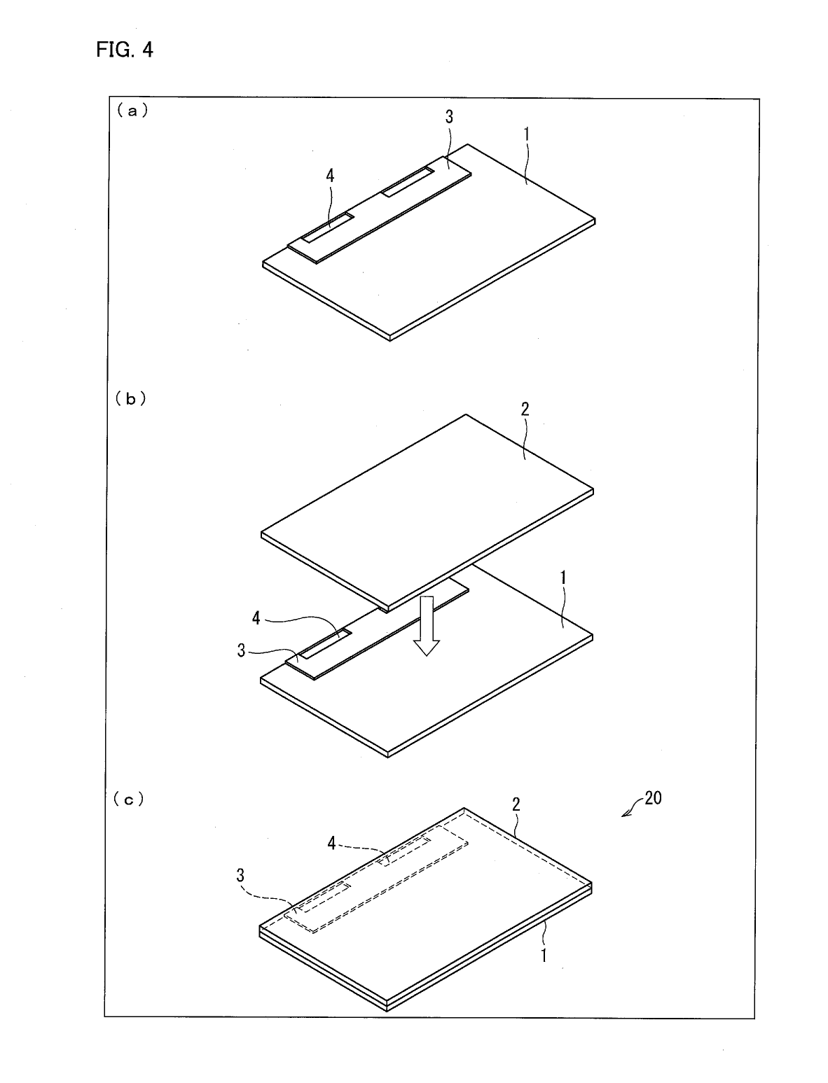

FIG. 4 schematically illustrates an overview of a process for producing the structure 20. First, the electrically conductive pattern 3 is formed on a surface of the first resin layer 1 ((a) of FIG. 4). Then, the second resin layer 2 is stacked on the first resin layer 1 so that the electrically conductive pattern 3 is provided between the first resin layer 1 and the second resin layer 2 ((b) of FIG. 4). Finally, the structure 20 is completed ((c) of FIG. 4).

### Advantages of Embodiment 2

According to Embodiment 2, as in the case of Embodiment 1, the missing part 4 in which the electrically conductive pattern 3 is missing is provided on the first resin layer 1, and the first resin layer 1 and the second resin layer 2 adhere to each other in the missing part 4. This makes it possible to prevent separation of the first resin layer 1 and the second resin layer 2 in a part in which the electrically conductive pattern 3 is provided.

According to Embodiment 2, at least a part of the electrically conductive pattern 3 is provided in the end portion of the first resin layer 1, and the missing part 4 is provided on the first resin layer 1 end side of the electrically conductive pattern 3 which is provided in the end portion of the first resin layer 1.

With the configuration, even in a case where the electrically conductive pattern 3 is provided in the end portion of the first resin layer 1, it is possible to suitably prevent separation of the first resin layer 1 and the second resin layer 2 at and near the end of the first resin layer 1 by providing the missing part 4 at and near the end of the first resin layer 1.

Note that according to a conventional technique, the first resin layer 1 and the second resin layer 2 are highly likely to be separated from each other in a case where the electrically conductive pattern 3 is provided in the end portion of the first resin layer 1. This is because of the reason below. As described earlier, since the first resin layer and the second resin layer 2 are more likely to be separated from each other in the part in which the electrically conductive pattern 3 is provided, it is necessary to prevent separation of the first resin layer 1 and the second resin layer 2 by providing a part in which the first resin layer 1 and the second resin layer 2 directly adhere to each other so as to surround the electrically conductive pattern 3 (a part in which no electrically conductive pattern is provided). However, it is difficult in the end portion of the first resin layer 1 to provide the part in which the first resin layer 1 and the second resin layer 2 directly adhere to each other so as to surround the electrically conductive pattern 3 (a part in which no electrically conductive pattern is provided).

In contrast, according to the present invention, the first resin layer 1 and the second resin layer 2, which adhere to each other in the missing part 4, can be prevented from being separated from each other in the part in which the electrically conductive pattern 3 is provided. This makes it possible to provide the electrically conductive pattern 3 in the end portion of the first resin layer 1.

(Modification)

Note that it is also possible to combine Embodiment 1 and Embodiment 2. Specifically, it is possible to provide the missing part 4 (i) in a place surrounded by the conductive pattern 3 and (ii) on the first resin layer 1 end side of the electrically conductive pattern 3 which is provided in the end portion of the first resin layer 1.

In addition, it is unnecessary to provide the electrically conductive pattern 3 in the end portion of the first resin layer 1. Such a configuration also makes it possible to obtain an effect of preventing separation of the first resin layer 1 and the second resin layer 2.

Furthermore, it is unnecessary to provide the missing part 4 on the first resin layer 1 end side. Such a configuration also makes it possible to obtain an effect of preventing separation of the first resin layer 1 and the second resin layer 2.

### Embodiment 3

Subsequently, the following description discusses a configuration in which a structure of the present invention is incorporated in an electronic device. The description of Embodiment 3 takes, as an example, a configuration in which the structure of the present invention is incorporated in a wireless communication apparatus. However, the technical scope of the present invention is not limited to the description of the embodiments below and of the drawings. Note that, for convenience, members having functions identical to those of the respective members described in Embodiments 1 and 2 are given respective identical reference numerals, and a description of those members is omitted.

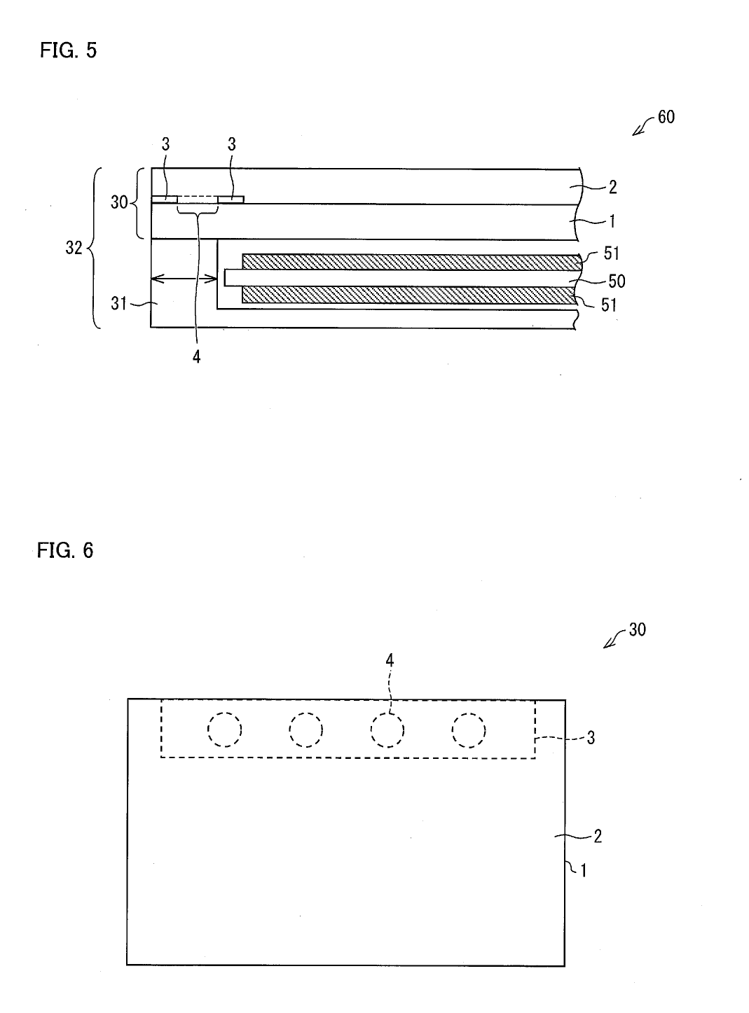

FIG. 5 is a side cross-sectional view schematically illustrating a configuration of a wireless communication apparatus 60 in accordance with Embodiment 3. As illustrated in FIG. 5, a structure 30 is incorporated in the wireless communication apparatus 60.

The structure (upper housing) 30, which, together with a lower housing 31, constitutes a housing 32 of the wireless communication apparatus 60, stores therein a circuit board (wireless circuit section) 50 and a mounting component/shield 51 mounted on the circuit board 50. The structure 30 includes a first resin layer 1, a second resin layer 2, an electrically conductive pattern 3, and a missing part 4 which is provided on the first resin layer 1. According to Embodiment 3, the electrically conductive pattern 3 functions as an antenna element. Specifically, the electrically conductive pattern 3 operates as an antenna of the wireless communication apparatus 60 by being fed with electric power which is supplied via a feeding path (not illustrated) from the wireless circuit section mounted on the circuit board 50.

FIG. 6 is a top view of the structure 30 which is observed from the first resin layer 1 side. As illustrated in FIG. 6, according to the structure 30, the electrically conductive pattern 3 is provided in an end portion of the first resin layer 1, and a missing part 4 which has a circular shape is provided in a place surrounded by the electrically conductive pattern 3. Note, however, that the missing part 4, which is not particularly limited in shape, can have any shape such as an elliptical shape, a quadrangular shape, or a polygonal shape.

Further, the missing part 4 preferably has a size which is set so as not to influence an antenna characteristic of an antenna constituted by the electrically conductive pattern 3. For example, the missing part 4 which has a circular shape can have a diameter of, for example, ⅛ wavelength with respect to a frequency of use (resonance frequency) of the antenna constituted by the electrically conductive pattern 3. Specifically, the missing part 4 which has an area being not more than ⅛ wavelength×⅛ wavelength with respect to a frequency of use of the antenna constituted by the electrically conductive pattern 3 makes it possible to suitably prevent an influence on the antenna characteristic.

### Advantages of Embodiment 3

According to Embodiment 3, as in the case of Embodiments 1 and 2, the missing part 4 in which the electrically conductive pattern 3 is missing is provided on the first resin layer 1, and the first resin layer 1 and the second resin layer 2 adhere to each other in the missing part 4. This makes it possible to prevent separation of the first resin layer 1 and the second resin layer 2 in a part in which the electrically conductive pattern 3 is provided.

This makes it possible to prevent a drift, caused by separation of the electrically conductive pattern 3 from the second resin layer 2, of a resonance frequency at which the antenna operates.

Further, as illustrated in FIG. 5, the electrically conductive pattern 3 which is provided in the end portion of the first resin layer 1 allows a longer distance between (a) the circuit board 50 and the mounting component/shield 51 each stored in the wireless communication apparatus 60 and (b) the electrically conductive pattern 3. This makes it possible to prevent a deterioration in antenna characteristic by causing the electrically conductive pattern 3 to have a long distance from the circuit board 50 and the mounting component/shield 51 each of which serves as a GND for the antenna, and avoiding unnecessary resonances caused by coupling of the electrically conductive pattern 3 with, for example, the circuit board 50 and the mounting component/shield 51.

As described earlier, according to a conventional technique, the first resin layer 1 and the second resin layer 2 are highly likely to be separated from each other in a case where the electrically conductive pattern 3 is provided in the end portion of the first resin layer 1. In contrast, according to the present invention, the first resin layer 1 and the second resin layer 2, which adhere to each other in the missing part 4, can be prevented from being separated from each other in the part in which the electrically conductive pattern 3 is provided. This makes it possible to successfully provide the electrically conductive pattern 3 in the end portion of the first resin layer 1. This makes it possible to obtain an effect (described earlier) of preventing a deterioration in antenna characteristic.

(Modification)

The missing part 4 is not particularly limited in shape and location. For example, the missing part 4 can be formed as in the case of the missing part 4 of Embodiment 2.

In addition, as in the case of Embodiment 1, the electrically conductive pattern 3 does not need to be provided in the end portion of the first resin layer 1. Such a configuration also makes it possible to yield an effect of preventing a drift, caused by separation of the electrically conductive pattern 3 from the second resin layer 2, of a resonance frequency at which the antenna operates.

### CONCLUSION

A structure (10) in accordance with an aspect of the present invention includes: a first resin layer (1); a second resin layer (2); and an electrically conductive pattern (3) provided on a surface of the first resin layer, the second resin layer being stacked on the first resin layer so that the electrically conductive pattern is provided between the first resin layer and the second resin layer, the first resin layer having thereon at least one missing part (4) in which the electrically conductive pattern is missing, and the first resin layer and the second resin layer adhering to each other in the at least one missing part.

According to the configuration, in the at least one missing part, the first resin layer and the second resin layer adhere to each other. This makes it possible for the first resin layer and the second resin layer to more strongly adhere to each other in a part in which the electrically conductive pattern is provided, and consequently to prevent separation of the first resin layer and the second resin layer in the part in which the electrically conductive pattern is provided.

The structure in accordance with an aspect of the present invention can be configured such that at least one of the at least one missing part is a missing part in which the electrically conductive pattern is missing so as to have an island shape.

The configuration makes it possible to more suitably prevent separation of the first resin layer and the second resin layer.

The structure in accordance with an aspect of the present invention can be configured such that at least one of the at least one missing part is surrounded by the electrically conductive pattern.

The configuration makes it possible to provide the at least one missing part at any location and to suitably prevent separation of the first resin layer and the second resin layer.

A structure (20) in accordance with an aspect of the present invention can be configured such that at least a part of the electrically conductive pattern is provided in an end portion of the first resin layer; and at least one of the at least one missing part is provided on the first resin layer end side of the at least the part of the electrically conductive pattern.

According to the configuration, in a case where the electrically conductive pattern is provided in the end portion of the first resin layer but the at least one missing part is provided at and near the end of the first resin layer, it is possible to suitably prevent separation of the first resin layer and the second resin layer in a part in which the electrically conductive pattern is provided.

A wireless communication apparatus (60) in accordance with an aspect of the present invention includes: a housing (32) including a structure (30) in accordance with an aspect of the present invention; and an antenna including the electrically conductive pattern.

According to the configuration, it is possible to prevent separation of the second resin layer and the electrically conductive pattern at an interface therebetween. This makes it possible to prevent a drift of a resonance frequency at which the antenna operates.

The wireless communication apparatus in accordance with an aspect of the present invention can be configured such that the at least one missing part has an area being not more than ⅛ wavelength×⅛ wavelength with respect to a frequency of use of the antenna.

The configuration allows a reduction in influence of the missing part on an antenna characteristic of the antenna.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is widely applicable to various electronic components in each of which a conductive pattern is used. In particular, the present invention is preferably applicable to but is not applicable only to a wireless communication apparatus in which an electrically conductive pattern is used as an antenna element.

### REFERENCE SIGNS LIST

10, 20, 30 Structure
1 First resin layer
2 Second resin layer
3 Electrically conductive pattern (Antenna)
4 Missing part
32 Housing
50 Circuit board
51 Mounting component/Shield
60 Wireless communication apparatus

1-5. (canceled)

6. A structure comprising:
a first resin layer;
a second resin layer; and
an electrically conductive pattern provided on a surface of the first resin layer by plating the surface with metal,
the second resin layer being molded, by insert-molding, on the first resin layer so that the electrically conductive pattern is provided between the first resin layer and the second resin layer,
the first resin layer having thereon at least one missing part in which the electrically conductive pattern is missing, and
the first resin layer and the second resin layer adhering to each other in the at least one missing part.

7. The structure as set forth in claim 6, wherein the electrically conductive pattern is formed by a Laser Direct Structuring (LDS) method.

8. The structure as set forth in claim 6, wherein at least one of the at least one missing part is a missing part in which the electrically conductive pattern is missing so as to have an island shape.

9. The structure as set forth in claim 6, wherein at least one of the at least one missing part is surrounded by the electrically conductive pattern.

10. The structure as set forth in claim 6, wherein the electrically conductive pattern is an antenna element.

11. A structure comprising:
a first resin layer;
a second resin layer; and
an electrically conductive pattern provided on a surface of the first resin layer, the second resin layer being stacked on the first resin layer so that the electrically conductive pattern is provided between the first resin layer and the second resin layer,
the first resin layer having thereon at least one missing part in which the electrically conductive pattern is missing, and
the first resin layer and the second resin layer adhering to each other in the at least one missing part, wherein
the electrically conductive pattern is an antenna element,
at least a part of the electrically conductive pattern is provided in an end portion of the first resin layer,
at least one of the at least one missing part is provided on the first resin layer end side of the at least the part of the electrically conductive pattern, and
the at least one of the at least one missing part has a first part which differs from a second part of the at least one of the at least one missing part which second part faces the end of the first resin layer and which is surrounded by the electrically conductive pattern.

12. The structure as set forth in claim 6, wherein the at least one missing part has an area being not more than ⅛ wavelength×⅛ wavelength with respect to a frequency of use of the antenna element.

13. A wireless communication apparatus comprising:
a housing including the structure recited in claim 6; and
an antenna including the electrically conductive pattern.

14. The structure as set forth in claim 11, wherein the at least one missing part has an area being not more than ⅛ wavelength×⅛ wavelength with respect to a frequency of use of the antenna element.

15. A wireless communication apparatus comprising:
a housing including the structure recited in claim 11; and
an antenna including the electrically conductive pattern.
